(19) United States
(12) Patent Application Publication
(10) Pub. No.: US 2023/0389567 A1
(43) Pub. Date: Dec. 7, 2023

(54) PLANT BASED SOFT SERVE OR FROZEN DESSERT MADE FROM CEREAL AND LEGUMES

(71) Applicant: SOCIETE DES PRODUITS NESTLE S.A., Vevey (CH)

(72) Inventors: LAURENT SAGALOWICZ, Blonay (CH); LAURENCE SANDOZ, Echallens (CH); MARIANNE STUDER, Morrens (CH); ELODIE AUDREY SOUSSAN, Epalinges (CH)

(21) Appl. No.: 18/247,659

(22) PCT Filed: Oct. 7, 2021
(86) PCT No.: PCT/EP2021/077780

§ 371 Date: Apr. 3, 2023

(30) Foreign Application Priority Data
Oct. 9, 2020 (EP) 20201087.2
Jul. 16, 2021 (EP) 21186233.9

(51) Int. Cl. A23G 9/42; A23G 9/38

(52) U.S. Cl. CPC A23G 9/42; A23G 9/38

(57) ABSTRACT

The invention relates in general to a soft serve emulsion composition or a frozen dessert composition, said composition comprising 1 to 10 wt % non-fractionated chickpea; 0.2 to 5 wt % non-fractionated oat; 1 to 45 wt % sugar; and 3 to 20 wt % fat source.

### FIELD OF THE INVENTION

The present invention relates to soft serve or frozen desserts made from non-fractionated cereals and legumes.

### BACKGROUND OF THE INVENTION

Recent years have seen a large increase in consumer interest for plant-based foods. This is driven in part by the good environmental sustainability of such products. Much of this increased interest has been seen in the market for frozen desserts. Prior art plant based frozen desserts use for the most part fractionated plant materials. For example, WO2017/001266 discloses an ice-cream containing vegetable proteins and protein extracts. Other prior art disclosures like US 2018/184684A1, WO 2018/122607A1 and US 2018/295849A1 cover frozen compositions or emulsions made with pulse or cereal proteins. Those protein extracts are usually produced chemically from cereals and pulses and have a protein content higher than 50%. In all these cases, protein extract isolates and concentrates are used together with artificial additives which provide the products with a sufficiently good sensory profile.

There is a clear need for new plant based chilled and frozen desserts which are viewed as clean label and have wholesome ingredients, and at the same time maintain the good sensory profile expected by the consumer.

Patent application CN 105595 187A uses germination of legumes and cereals to produce an emulsion for nutritious purposes and it is not adapted to Soft Serve emulsion applications. In addition, germination is complicated, expensive and may create microbiological issue since it requires to leave the grains more than 24 hours in water and a simple more cost-effective way to produce soft serve emulsion is required.

### SUMMARY OF THE INVENTION

A specific combination of cereal and legume can be processed which has a surprisingly good sensory profile, whilst maintaining an overall clean label list of ingredients.

It addresses the problems in the prior art by using entire grains, hulled grain, or a flour made of entire grain or flour.

A method has been developed to produce compositions using entire (or de-hulled) chickpea or chickpea flour and oat or oat flour, without the need for adding protein-enriched extract.

### Embodiments of the Invention

One embodiment of the present invention relates to a soft serve emulsion composition or frozen dessert composition, said composition comprising
a. 1 to 10 wt % non-fractionated chickpea;
b. 0.2 to 5 wt % non-fractionated oat;
c. 1 to 45 wt % sugar; and
d. 3 to 20 wt % fat source.

In one embodiment, the invention relates to a soft serve emulsion composition. In one embodiment, the invention relates to a frozen dessert composition.

The composition of the present invention may be a vegan food composition. Hence, the soft serve emulsion composition or frozen dessert composition of the present invention may be a vegan soft serve emulsion composition or frozen dessert composition.

The composition may comprise 0.5 to 5 wt % protein, preferably 0.8 to 3% protein, preferably 1 to 2% protein, wherein greater than 50% of the protein is provided by one or more of the non-fractionated chickpea and non-fractionated oat, preferably greater than 80% of the protein is provided by one or more of the non-fractionated chickpea and non-fractionated oat, preferably greater than 95% of the proteins is provided by one or more of the non-fractionated chickpea and non-fractionated oat.

The composition of the present invention may further comprise 1 to 10 wt % starch, preferably 2 to 8 wt % starch, and/or 0.2 to 5 wt % dietary fiber, preferably 0.4 wt % to 7 wt % dietary fiber.

The composition may have an amino acid score greater than 0.9, preferably greater than 1, preferably greater than 1.05, preferably greater than 1.1; and/or the composition may have an overrun of between 15 to 100%, preferably 20 to 50%, preferably 35%.

The non-fractionated chickpea and/or the non-fractionated oat may be hydrolyzed.

Preferably, the non-fractionated chickpea and non-fractionated oat are non-germinated.

The subject matter of the present invention also relates to a method of making a plant based liquid, soft serve emulsion, or a frozen dessert composition, said method comprising
a. Mixing 1 to 10 wt % non-fractionated legume, 0.2 to 5 wt % non-fractionated cereal, sugar, and optionally pectin in water to form a mixture;
b. Heating the mixture to induce starch gelation;
c. Optionally homogenizing the mixture;
d. Adding a fat source to the mixture;
e. Homogenizing the mixture comprising the fat source at relatively low shear to obtain large fat particle sizes to remain and gives a creamy frozen dessert without graininess;
f. Optionally adding flavor to the mixture;
g. Applying a thermal heat treatment to the mixture to form a plant based liquid composition; and
h. Optionally freezing the plant-based liquid to form a frozen dessert composition which will be conserved frozen, or
i. Optionally storing the emulsion at room temperature or chilled and use the emulsion to make a soft serve ice-cream either in a restaurant or at home.

In one embodiment, the invention relates to a method of making a plant based liquid. In one embodiment, the invention relates to a method of making a soft serve emulsion.

In one embodiment, the invention relates to a method of making a frozen dessert composition.

In one embodiment, 1 to 10 wt % non-fractionated legume is mixed.

The plant-based liquid obtained in step g) may comprise lipid droplets having a maximum diameter greater than 1 microns, preferably greater than 2 microns, preferably greater than 4 microns, more preferably greater than 6 microns; and/or may have a D4,3 particle size less than 100 microns, preferably less than 75 microns, preferably less than 50 microns, preferably less than 40 microns, more preferably less 30 microns, even more preferably less than 20 microns.

The subject matter of the present invention further extends to the use of 1 to 10 wt % non-fractionated chickpea and 0.2 to 5 wt % non-fractionated oat in the manufacture of a soft serve emulsion composition or a frozen dessert composition.

### DETAILED DESCRIPTION OF THE INVENTION

When a composition is described herein in terms of wt %, this means wt % of the total recipe, unless indicated otherwise.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth.

The term “vegan” refers to an edible composition which is entirely devoid of animal products, or animal derived products.

Non-fractionated source of legume or cereal refers to whole grains, de-hulled grains, or flours derived therefrom. Preferably, a non-fractionated source of legume or cereal is a flour. This is very different to the ingredient normally used in the prior art to produce frozen desserts or Soft Serve emulsions where a protein extract is used, which contain typically more than 50 wt % protein. In the present invention, the non-fractionated chickpea or oat and corresponding flours, contain less than 50 wt % protein, preferably less than 40 wt % protein even more preferably less than 30 wt % protein. Non-fractionated oat flour contains preferably less than 20% protein. In the present invention, the proteins are mixed within the whole or dehulled grain matrix and it is surprising that in this form they can stabilize oil droplets

Fat sources may include any kind of vegetable fat and/or oil. Vegetable fat and/or oils include coconut oil, for example refined coconut fat, palm fat, shea fat, tropical fat, sunflower oil, soybean oil, oat oil, rice oil, canola oil, rapeseed oil, lemon oil, orange oil, safflower oil, cotton seed oil, nut oil, pumpkin seed oil, sesame oil, almond oil, peanut oil, flaxseed oil, cocoa butter oil, watermelon seed oil, egusi oil, hemp oil, flaxseeds oil, chia oil, fruit oil, avocado oil and olive oil.

The oil or fat may also be directly extracted during the process starting from full grains, pulses or seeds.

Sugar sources may include sucrose, cane sugar, beat sugar, glucose syrup, maltodextrin, honey and other natural sugar syrups such as agave, or combinations thereof. Preferably, the sugar is sucrose, saccharose, galactose or glucose. Preferably the sugar source includes sucrose and glucose.

Any kind of stabilizers can also be used such as pectin, gum, guar gum, locust bean gum, carrageenan, gellan gum, alginate, sodium alginate, agar, gum Arabic, and pectin.

At least one emulsifier may also be used such as monoglyceride, phospholipids, galactolipids, sugar esters, polysorbate, polyglycerol polyricinoleate Spans, sugar ester or combinations thereof. Emulsifiers also include mono- and diglycerides of fatty acids and their esters with acetic, citric, lactic, and mono- and diacetyl tartaric or tartaric acids; polyglycerol fatty acid esters; polyoxyethylene sorbitan fatty acid esters, citric, lactic, and mono- and diacetyl tartaric or tartaric acids; polyglycerol fatty acid esters; propylene glycol fatty acid esters; stearoyl-2-lactylate salts; and sugar esters, ammonium phosphatide, fatty acid salts and glycerol esters.

Emulsifiers and stabilizers can be present in extracts. Those extracts include for example lecithin, oat oil, fractionated oat oil and/or commercial extracts.

Thermal treatment can be within a range of 70° C. to 155° C. for 3 seconds to 60 seconds using direct or indirect thermal heat treatment or steam injection. Thermal treatment includes UHT heat treatment, which can be within a range of 100° C. to 150° C.

A soft serve emulsion is typically an oil in water emulsion. Transformation of a soft serve emulsion to a frozen dessert is accomplished by using a special machine that holds the soft serve emulsion at a temperature of about 4° C. at the point of sale. The frozen dessert is obtained by applying below zero temperatures (e.g. in the range −4 to −6° C.), introduction of gas bubbles and shear. They are typically used at fairs, fast food restaurant and specialty shops. For application in restaurants, the soft serve emulsion needs to be very stable. Products need to be kept at room temperature for more than 6 months. In addition, soft serve machines are not emptied and cleaned every day. This means that the product needs to remain stable at least for one week being whilst maintained at 4° C. but also stable upon heating to more than 70° C. for up to one hour every day for microbial stability. This is particularly demanding for the Soft Serve emulsion especially when using plant-based ingredients. An emulsion used for standard frozen desserts, which are sold frozen in a shop can be very different since they do not have to be stable for 6 months or during the cycling of a Soft Serve machine.

The term “vegan food composition” refers to an edible composition which is entirely devoid of animal products, or animal derived products. Non-limiting examples of animal products include meat, eggs, milk, and honey.

A cereal is any grass cultivated (grown) for the edible components of its grain (botanically, a type of fruit called a caryopsis), composed of the endosperm, germ, and bran. The following cereals can be used in the vegan food composition according to the invention: oat, quinoa, maize (corn), rice, wheat, buckwheat, spelt grains, barley, sorghum, millet, rye, triticale, and fonio. Preferably, the cereal is selected from oat, corn, millet, and quinoa. Preferably, the cereal is oat.

A legume is a plant in the family Fabaceae (or Leguminosae), the seed of such a plant (also called pulse). Legumes are grown agriculturally, primarily for human consumption, for livestock forage and silage, and as soil-enhancing green manure.

The following legumes can be used in the vegan food composition according to the invention: lentil, chickpea, beans, and peas, for example kidney beans, navy beans, pinto beans, haricot beans, lima beans, butter beans, azuki beans, mung beans, golden gram, green gram, black gram, urad, fava beans, scarlet runner beans, rice beans, garbanzo beans, cranberry beans, lima beans, green peas, snow peas, snap peas, split peas and black-eyed peas, groundnut, and Bambara groundnut. Preferably, the legume is selected from chickpea, lentil, cow pea, fava bean (faba bean), and green pea. Preferably, the legume is chickpea. Preferably, the legume is de-hulled. Preferably, the legume is roasted. Preferably, the legume is de-hulled, roasted chickpea. The legume can also be deflavored.

The preferred range of dietary fiber in the composition according to the invention is 0.2 to 5 wt %, preferably 0.4 to 7 wt % dietary fiber.

The preferred range of protein in the composition according to the invention is 0.5 to 5 wt % protein, preferably 0.8 to 3 wt % protein, preferably 1 to 2 wt % protein.

The preferred range of starch in the composition according to the invention is 1 to 10 wt % starch, preferably 2 to 8 wt % starch.

The preferred range of sugar in the composition according to the invention is 5 to 40 wt %, preferably 8 to 35 wt %, preferably 10 to 30 wt %, even more preferably 12 to 26 wt % sugar.

All particle sizes described herein apply to the plant-based liquid. D4,3, D90 and D50 particle sizes have to be determined by a method adapted to water, for example light scattering.

In one embodiment, the D90 particle size (for the volume weighted size distribution) is less than 300 microns, preferably less than 200 microns, preferably less than 100 microns. D90 (for the volume weighted distribution) is the diameter of particle, for which 90% of the volume of particles have a diameter smaller than this D90.

In one embodiment, micronization, shear treatment or homogenization is performed to reduce the particle size so that the D50 is lower than 60 microns, preferably lower than 50 microns, preferably lower than 40 microns. D50 (for the volume weighted distribution) is the diameter of particle, for which 50% of the volume of particles have a diameter smaller than this D90. The particle size distribution (weighted in volume) for a powder can be determined by automatized microscopy technique. This may be obtained using a CamSizer (Camsizer XT Retsch) or by dispersing the particle in water using a rotor-stator and performing light scattering. For a liquid, it can be determined using light scattering. In the following text, D90 and D50 are always used for a volume weighted size distribution and describe the particle diameter. Volume weighted size distribution is very familiar for one skilled in the art.

D4,3 particle size distribution in the composition according to the invention is less than 100 microns, preferably less than 75 microns, preferably less than 50 microns, preferably less than 40 microns, preferably less than 30 microns, preferably less than 20 microns.

Measurement of D4,3 (or D[4,3]) is well known to those skilled in the art as being the sum of the size to the power 4 weighted by their frequency of appearance divided by the sum of the size to the power 3 weighted by their frequency of appearance. The De Brouckere mean diameter is the mean of a particle size distribution weighted by the volume (also called volume-weighted mean diameter, volume moment mean diameter or volume-weighted mean size). It is the mean diameter, which is directly obtained in particle size measurements, where the measured signal is proportional to the volume of the particles. The most prominent examples are laser diffraction and acoustic spectroscopy (Coulter counter).

The De Brouckere mean is defined in terms of the moment-ratio system as,

$$D [ 4 , 3 ] = \frac{\sum {n}_{i} {D}_{i}^{4}}{\sum {n}_{i} {D}_{i}^{3}}$$

Where nᵢ is the frequency of occurrence of particles in size class i, having a mean Di diameter.

The D90 particle size distribution in the liquid vegan food composition according to the invention is lower than 400 microns, preferably lower than 300 microns, preferably lower than 200 microns, preferably lower than 100 microns, preferably lower than 80 microns.

The D50 particle size distribution in the liquid vegan food composition according to the invention is lower than 50 microns, preferably lower than 40 microns, preferably lower than 30 microns, preferably lower than 20 microns.

The composition according to the invention comprises between 2-25 wt % fat source, preferably 3-20 wt %, preferably 4-18 wt %, even more preferably 3-17 wt %

The preferred range of carbohydrate content of the composition according to the invention is between 5 and 45 wt %, preferably between 8 and 40 wt %, even more preferably between 10 and 35 wt %, which does not include contribution from the dietary fibers of the composition.

Protein quality is closely associated with the various essential amino acid ratios. The amino acid ratio for a given essential amino acid is defined by the quantity of this essential amino acid in mg divided by total protein in g. There are accepted standard values for these ratios for each essential amino acid (Protein quality evaluation, Report of the joint FAO-WHO Expert Consultation Bethesda Md USA 4-8 Dec. 1989), which defines if a protein source contains enough of this essential amino acid. For many protein sources such as nuts, seeds and cereals, the limiting amino acid is lysine and in addition, lysine degrades during food processing due to association with other nutrients and Maillard reaction (Tome, D. & Bos, C. Lysine requirement through the human life cycle. Journal of Nutrition 137, 1642S-1645S (2007)). It should be noted that in a final product, lysine amount is even lower due to chemical reaction. The amino acid ratio for a given essential amino acid is defined by the quantity of this essential amino acid in mg divided by total protein in g. The normalized amino acid ratio for any essential amino acids refers to the amino acid ratio divided by a standard essential amino acid quantity for each amino acid. This standard amino acid quantity is taken for lysine to be 48 mg/g of protein, for theorine 25 mg/g, for Isoleucine 30 mg/g, for leucine 61 mg/g, for valine 40 mg/g, for histidine 16 mg/g, and aromatic amino acids, which are the sum phenylalamine+tyrosine, 41 mg/g. Sulphurous amino acids, which are the sum methyonine and cysteine, 23 mg/g and triptophan 6.6 mg/g. These values are in accordance with recommendations for kids older than 4 years, adolescents and adults (FAO. Dietary protein quality evaluation in human nutrition. Report of an FAO Expert Consultation. FAO Food and Nutrition Paper 92. 2013). The amino acid score is the lowest value of all the normalized amino acid ratio corresponding to the amino acids cited above. The amino acid score should be greater than 0.9, preferably greater than 1, preferably greater than 1.05, preferably greater than 1.1.

The composition of the present invention may comprise at least 2 wt % chickpea, preferably at least 3 wt % Chickpea. Chickpeas are well known in the art as a healthy, nutrient-dense food, providing a rich content of protein, dietary fiber, folate, and certain dietary minerals, such as iron and phosphorus. In addition, chickpeas are known to comprise thiamin, vitamin B6, magnesium, and zinc. Hence, a high chickpea content is desirable.

The composition of the present invention may have an overrun of between 15 to 100%, preferably 20 to 50%, preferably 35%. In ice cream the term “overrun” is defined as the % increase in volume of the ice cream compared to the amount of mix used to produce that ice cream. An overrun can, hence, be caused by gas inclusion in the composition, for example, by gas or air inclusion. A high amount of overrun will, hence, produce a light creaminess in the composition of the present invention. However, too high an overrun will result in a loss of flavor density and a loss in the indulgent experience resulting from the consumption of the composition of the present invention. Particularly promising results are obtained with an overrun in the range of 30-40%.

The chickpea and oat components may be distributed unevenly in the composition of the present invention so that the chickpea and oat components may be present in a concentrated fashion, for example as sprinkles or as concentrated composition. It is preferred, however, if the chickpea and oat components are present in a continuous phase. In a particularly preferred embodiment of the present invention, the chickpea and oat components are distributed homogeneously throughout the whole composition of the present invention. Hence, the chickpea and oat components may be present in the interior of the composition.

The composition of the present invention may further be dehydrated and provided as powder or granulate. Such a composition in powder or granulate form has the advantage that it has longer shelf life than the soft serve emulsion composition or frozen dessert composition of the present invention comprising a water content. Such a powder or granulate may then be rehydrated before use, e.g. in a soft ice cream machine. Hence, the subject matter of the present invention also includes a powder, obtainable and/or obtained by drying the soft serve emulsion composition or frozen dessert composition of the present invention.

The present invention further comprises a method to prepare the composition of the present invention. Hence, the present invention relates in part to a method of making a plant-based liquid, soft serve emulsion, or a frozen dessert composition, said method comprising
a. Mixing 1 to 10 wt % non-fractionated legume, 0.2 to 5 wt % non-fractionated cereal, sugar, and optionally pectin in water to form a mixture;
b. Heating the mixture to induce starch gelation;
c. Adding a fat source to the mixture;
d. Homogenizing the mixture comprising the fat source, and
e. Applying a thermal heat treatment to the mixture to form a plant based liquid composition.

The present invention further comprises a method to prepare the composition of the present invention. Hence, the present invention relates in part to a method of making a plant-based liquid, soft serve emulsion, or a frozen dessert composition, said method comprising
a. Mixing 1 to 10 wt % non-fractionated legume, 0.2 to 5 wt % non-fractionated cereal, sugar, and optionally pectin in water to form a mixture;
b. Heating the mixture to induce starch gelation;
c. Adding a fat source to the mixture;
d. Homogenizing the mixture comprising the fat source at relatively low shear to obtain large fat particle sizes to remain and gives a creamy frozen dessert without graininess, and
e. Applying a thermal heat treatment to the mixture to form a plant based liquid composition.

In one embodiment, the invention relates to a method of making a plant based liquid. In one embodiment, the invention relates to a method of making a soft serve emulsion. In one embodiment, the invention relates to a method of making a frozen dessert composition.

In one embodiment, 3 to 10 wt % non-fractionated legume is mixed.

The sugar may be added to modify the freezing behavior and to reduce and/or the avoid the build-up of ice crystals. Of course, sugar addition also has an advantageous effect on taste.

After the heating step, a homogenization step may be carried out. A homogenization step, for example a homogenization step at high shear, may be included to break grain and cereal particles and to break the gel. It is preferred that fat is not introduced until after this homogenization step.

The homogenization step after the addition of the fat source may be carried out at low shear. This homogenization step allows large fat particle sizes to remain and results in a creamy structure without graininess. After homogenization typically an emulsion results.

Optionally, flavor may be added to the mixture. The addition of flavor allows it to adjust the composition of the present invention to many consumer taste preferences and consumption occasions.

Once the homogenization step results in an essentially creamy structure without graininess, a heat treatment is applied to form a plan-based liquid composition.

This plant-based liquid composition may then optionally be frozen to form a frozen dessert composition. This frozen dessert composition may be to be conserved frozen.

Further optionally, the plant-based liquid composition may be stored at room temperature or under chilled conditions. As said before, at this stage the plant-based liquid composition is typically an emulsion. The plant-based liquid composition may then be used to make a soft serve ice-cream either in a restaurant or at home.

Very good results were obtained, when the non-fractionated legume was chickpea and the non-fractionated cereal was oat. Chickpea is considered very good for the health. All the essential amino acids are present and the amino acid score is 1.09. It contains also more than 10 wt % fiber. It has a good taste. In addition, it also contains folate, and certain dietary minerals, such as iron and phosphorus. Furthermore, chickpeas are known to comprise thiamin, vitamin B6, magnesium, and zinc. It is relatively easy to micronize. It contains also about 50% starch. Starch gelation can be a severe issue but with the process developed in the present invention which includes a heating treatment above 80° C. followed by micronization or homogenization, final viscosity is controlled, and starch is bringing a nice mouthfeel. Chickpea and chickpea flours are commodities and inexpensive.

Oat is a good source of healthy nutrients. In terms of nutrition, it contains also more than 10 wt % fibers which include beta glucan known for their health benefit including lowering cholesterol, improving blood sugar management, and boosting the immune system. All the essential amino acids are present and the amino acid score is 0.87 with lysine being the limited amino acids. It is more difficult to micronize than chickpea. It contains about 55% starch, which similarly to the chickpea is used to bring nice mouthfeel. Finally, due to the presence of very healthy nutrients such as beta glucan, oat provides a very nice image to consumers. In addition, oat and oat flours are even cheaper than chickpea.

Mixing chickpea and oat brings advantages of both sources. In addition, the amino acid balance gets even improved. For a mixture containing 60% chickpea and 40% oat, amino acid score is 1.2 which is much higher than both chickpea and oat on their own. Concerning the process, if the content of oat remains less than 50 wt % (referring to the total combined amount of chickpea and oat), there is no issue for micronization. Finally, it was surprising to see that the combination of oat and chickpea delivered unexpected taste preference. For example, for mixtures where the amount of oat was about 20 wt % (referring to the total of chickpea and oat), the resulting taste was judged as superior compared to oat and chickpea on their own.

In the heating step to induce starch gelation in the mixture the mixture may be heated to at least 70° C. to induce gelatinization in step b), preferably at least 80° C.

After addition of the fat, very good results were obtained, when the mixture comprising the fat source was homogenized at about 80/20 bars or less.

The plant based liquid obtained after applying a thermal heat treatment to the mixture to form a plant based liquid composition may comprise lipid droplets having a maximum diameter greater than 1 microns, preferably greater than 2 microns, preferably greater than 4 microns, more preferably greater than 6 microns. In one embodiment of the present invention at least 10%, at least 20%, at least 30%, at least 40%, or at least 50% of the lipid droplets have a maximum diameter greater than 1 microns, preferably greater than 2 microns, preferably greater than 4 microns, more preferably greater than 6 microns.

The plant based liquid obtained after applying a thermal heat treatment to form a plant based liquid composition may have a D4,3 particle size of less than 100 microns, preferably of less than 75 microns, preferably of less than 50 microns, preferably of less than 40 microns, more preferably of less 30 microns, even more preferably of less than 20 microns. The smaller the particle size, the smoother the indulging consumption experience will likely be.

Very good results in terms of consumption experience and feasibility of transforming the emulsion into a frozen dessert were obtained when the a plant based liquid composition obtained after applying a thermal heat treatment to form a plant based liquid composition had a viscosity higher than 0.001 Pa s, preferably higher than 0.002 Pa·s, preferably higher than 0.005 Pa·s, preferably higher than 0.01 Pa·s, more preferably higher than 0.05 Pa·s as measured at 25° C. with apparatus at a shear rate of 100 s⁻¹.

Typical kitchen or industrial ice-cream machines, soft serve machines or sorbet machines, all well known to the person skilled in the art, can be used to transform the emulsion or the plant-based liquid of this invention into a frozen dessert. Those can include freezing, shear, obtained for example using a stirring scrapper, to maintain small size of ice crystals and optionally means to introduce air into the frozen dessert.

Finally, the subject matter of the present invention further relates to the use of 1 to 10 wt %, or 3 to 10 wt % non-fractionated chickpea and 0.2 to 5 wt % non-fractionated oat in the manufacture of a soft serve emulsion composition or a frozen dessert composition.

One embodiment of the present invention relates to a soft serve emulsion composition or frozen dessert composition, said composition comprising
a. 1 to 10 wt % non-fractionated chickpea;
b. 1 to 45 wt % sugar; and
c. 3 to 20 wt % fat source.

The composition of the present invention may be a vegan food composition. Hence, the soft serve emulsion composition or frozen dessert composition of the present invention may be a vegan soft serve emulsion composition or frozen dessert composition.

The non-fractionated chickpea may be hydrolyzed.

The composition may comprise 0.5 to 5 wt % protein, preferably 0.8 to 3% protein, preferably 1 to 2% protein, wherein greater than 50% of the protein is provided by the non-fractionated chickpea, preferably greater than 80% of the protein is provided by the non-fractionated chickpea, preferably greater than 95% of the proteins is provided by the non-fractionated chickpea.

The composition of the present invention may further comprise 1 to 10 wt % starch, preferably 2 to 8 wt % starch, and/or 0.2 to 5 wt % dietary fiber, preferably 0.4 wt % to 7 wt % dietary fiber.

The composition may have an amino acid score greater than 0.9, preferably greater than 1, preferably greater than 1.05, preferably greater than 1.1; and/or the composition may have an overrun of between 15 to 100%, preferably 20 to 50%, preferably 35%.

The subject matter of the present invention also relates to a method of making a plant based liquid, soft serve emulsion, or a frozen dessert composition, said method comprising
a. Mixing 1 to 10 wt % non-fractionated legume, cereal, sugar, and optionally pectin in water to form a mixture
b. Heating the mixture to induce starch gelation;
c. Adding a fat source to the mixture;
d. Homogenizing the mixture comprising the fat source;
e. Optionally adding flavor to the mixture;
f. Applying a thermal heat treatment to the mixture to form a plant based liquid composition; and
g. Optionally freezing the plant-based liquid to form a frozen dessert composition, or
h. Optionally storing the emulsion at room temperature or chilled and use the emulsion to make a soft serve ice-cream.

The subject matter of the present invention further relates to a method of making a plant based liquid, soft serve emulsion, or a frozen dessert composition, said method comprising
a. Mixing 1 to 10 wt % non-fractionated legume, cereal, sugar, and optionally pectin in water to form a mixture
b. Heating the mixture to induce starch gelation;
c. Adding a fat source to the mixture;
d. Homogenizing the mixture comprising the fat source at relatively low shear to obtain large fat particle sizes to remain and gives a creamy frozen dessert without graininess;
e. Optionally adding flavor to the mixture;
f. Applying a thermal heat treatment to the mixture to form a plant based liquid composition; and
g. Optionally freezing the plant-based liquid to form a frozen dessert composition which will be conserved frozen, or
h. Optionally storing the emulsion at room temperature or chilled and use the emulsion to make a soft serve ice-cream either in a restaurant or at home.

In one embodiment, the invention relates to a method of making a plant based liquid. In one embodiment, the invention relates to a method of making a soft serve emulsion. In one embodiment, the invention relates to a method of making a frozen dessert composition.

The non-fractionated chickpea may be hydrolyzed.

In one embodiment, 3-10 wt % non-fractionated legume is mixed.

The plant-based liquid obtained in step g) may comprise lipid droplets having a maximum diameter greater than 1 microns, preferably greater than 2 microns, preferably greater than 4 microns, more preferably greater than 6 microns; and/or may have a D4,3 particle size less than 100 microns, preferably less than 75 microns, preferably less than 50 microns, preferably less than 40 microns, more preferably less 30 microns, even more preferably less than 20 microns.

In one embodiment, cocoa powder or cocoa liquor can be added. This way, a chocolate version of the soft serve emulsion or frozen dessert may be obtained.

In one embodiment, fruit puree can be added, for example a strawberry puree.

Cocoa powder may be obtained by cleaning, breaking, de-shelling, alkalizing roasting, grinding, pressing and tempering. This process results in a partially defatted powder from cocoa bean. The final fat content of the cocoa powder is typically in the range 10 to 12 wt %.

Cocoa liquor may be obtained by fermenting, drying, roasting, and separating the cocoa bean from their skins.

In a preferred embodiment, chocolate powder or liquor is added at a range between 0.5 and 15 wt %, preferably between 1 and 10 wt %, preferably between 2 and 5 wt %.

In a preferred embodiment, greater than 50% of the protein is provided by one or more of the non-fractionated chickpea, non-fractionated oat and chocolate powder or liquor preferably greater than 80% of the protein is provided by one or more of the non-fractionated chickpea, non-fractionated oat and chocolate powder or liquor, preferably greater than 95% of the proteins is provided by one or more of the non-fractionated chickpea, non-fractionated oat and chocolate powder or liquor.

The subject matter of the present invention further extends to the use of 1 to 10 wt %, or 3 to 10 wt % non-fractionated chickpea in the manufacture of a soft serve emulsion composition or a frozen dessert composition.

### Example 1

Chickpea Based Soft Serve Emulsion and Frozen Dessert

6.4 wt % chickpea flour (AGT food) was dispersed in 69.12% water. Chickpea flour was analyzed, and the starch content was 45 wt %, protein 25 wt %, fat 6 wt %, dietary fiber 12 wt % and sugar 8 wt %. A dry mix was made of 0.2 wt % pectin and 15 wt % sugar and added to the chickpea flour dispersion to form a mixture. The mixture was then introduced into a Tetra Almix B200-100 VA Scanima reactor (Germany) and heated to 95° C. The temperature was maintained for 10 minutes at 95° C. in order to gelatinize the starch and to form a stable gel. The mixture was then homogenized in a valve homogenizer (APV, HTST, Germany) using a pressure of 350/50 bars in order to break the gel and avoid the perception of graininess in the final frozen dessert product. 8 wt % of refined coconut fat was mixed with 0.4 wt % saturated monoglyceride at 75° C. to obtain a homogeneous lipid solution. The lipid solution was added to the chickpea/pectin/sugar mixture. A pre-emulsion was obtained using a rotor stator. The complete dispersion was passed through the valve homogenizer (APV, HTST, Germany) using a relatively low pressure (80/20 bars). Oil droplets with a maximum size of about 5 microns were obtained as revealed by confocal microscopy using Nile red staining. 0.2 wt % vanilla custard, 0.5 wt % milk cream flavor and 0.08 wt % Tonka flavor were added. The mixture was treated by ultra-high temperature treatment (UHT) using a temperature of 143° C. for 5 seconds (APV, HTST, Germany) to form a soft serve emulsion emulsion.

The particle size of the obtained dispersion was determined using a Malvern 3000 instrument using the Mie model with stirrer speed 2000, material name: coconut oil, refractive index 1.54, particle density 0.90 and absorption index 0.01, dispersant was water with sugar and corresponding refractive index 1.35. Result is the average of 5 measurements. D4,3 was found to be 12.3 microns, D3,2 was found to be 1.6 microns, Dx(90) was found to be 32.6 microns while the Dx(50) was 4 microns.

The soft serve emulsion was passed through a Carpigiani ice-cream maker model Labo/8 12 E max capacity 2.5 L to obtain a frozen dessert. The freezing time for 1 litre of emulsion was about 15 min. Overrun was about 35%.

### Example 2

Soft Serve Emulsion and Frozen Dessert Comprising Chickpea and Oat in a 4:1 Ratio

5.1 wt % chickpea flour (AGT food) and 1.3 wt % oat flour (GMSA, Switzerland) were mixed with 68.87 wt % water to form a dispersion.

Chickpea flour was analyzed, and starch was 45%, protein 25%, fat 6%, dietary fiber 12% and sugar 8%. Oat flour contains 56% of starch, 13% of protein, 7% of fat, 10% dietary fiber and 1.2% sugar. 0.2% Pectin and 15% sugar were dry mixed together and added to the dispersion. The dispersion was then introduced into a Tetra Almix B200-100 VA Scanima reactor (Germany) and heated to 95° C. The temperature was maintained for 10 minutes at 95° C. in order to gelatinize the starch and to form a stable gel. The gel was then homogenized in a valve homogenizer (APV, HTST, Germany) using a pressure of 350/50 bars to break the gel and avoid a graininess perception in the final frozen dessert product. 8 wt % of refined coconut fat was mixed with 0.4 wt % saturated monoglyceride at 75° C. to obtain a homogeneous lipid solution. The lipid solution was added to the homogenate. A pre-emulsion was obtained using a rotor stator. The complete dispersion was passed through the valve homogenizer (APV, HTST, Germany) using a relatively low pressure (80/20 bars) to obtain oil droplets with a maximum size of 5 microns as revealed by confocal microscopy using Nile red staining. 0.3 wt % vanilla custard, 0.75 wt % milk cream flavor and 0.08 wt % Tonka flavor were added. The liquid was treated by ultra-high temperature treatment (UHT) using a temperature of 143° C. for 5 seconds (APV, HTST, Germany) and a soft serve emulsion was obtained.

The particle size of the obtained dispersion was determined using a Malvern 3000 instrument using the Mie model with stirrer speed 2000, material name: coconut oil, refractive index 1.54, particle density 0.90 and absorption index 0.01, dispersant was water with sugar and corresponding refractive index 1.35. Result is the average of 5 measurements. D4,3 was found to be 10.6 microns, D3,2 was found to be 2 microns, Dx(90) was found to be 25 microns while the Dx(50) was 4.4 microns.

Emulsion was then passed through a Carpigiani ice-cream maker model Labo/8 12 E max capacity 2.5 L, for 1 L freezing time about 15 min. The overrun was about 35%. The sample was tasted by 20 people. It was found that the frozen dessert had a very pleasant taste and mouthfeel with vanilla aroma. The mouthfeel was comparable to a typical ice cream made with milk fat components. A nice flavour could be obtained and addition of cereal to the ice-cream enables an amino acid score of 1.15 to be obtained, which is superior to what would be obtained for oat and chickpea on their own. Addition of oat also lowers the price and brings a nice image.

### Example 3

Soft Serve Emulsion and Frozen Dessert Comprising Chickpea and Oat in a 1:1 Ratio

3.2 wt % chickpea flour (AGT food) and 3.2 wt % oat flour (GMSA, Switzerland) were mixed with 68.87% water to form a dispersion. Chickpea flour was analyzed and starch was 45%, protein 25%, fat 6%, dietary fiber 12% and sugar 8%. Oat flour contains 56% of starch, 13% of protein, 7% of fat, 10% dietary fiber and 1.2% sugar. 0.2 wt % Pectin and 15 wt % sugar were dry mixed together and added to the dispersion. The dispersion was then introduced into a Tetra Almix B200-100 VA Scanima reactor (Germany) and heated to 95° C. The temperature was maintained for 10 minutes at 95° C. in order to gelatinize the starch and to form a stable gel. The gel was then homogenized in a valve homogenizer (APV, HTST, Germany) using a pressure of 300/50 bars to break the gel and avoid a graininess perception in the final frozen dessert product. 8 wt % of refined coconut fat was mixed with 0.4 wt % saturated monoglyceride at 75° C. to obtain a homogeneous lipid solution. The lipid solution was added to the homogenate. A pre-emulsion was obtained using a rotor stator. The complete dispersion was passed through the valve homogenizer (APV, HTST, Germany) using a relatively low pressure (80/20 bars) to obtain oil droplets with a maximum size of about 7 microns as revealed by confocal microscopy using Nile red staining. 0.3 wt % vanilla custard, 0.75 wt % milk cream flavor and 0.08 wt % Tonka flavor were added. The liquid was treated by ultra-high temperature treatment (UHT) using a temperature of 143° C. for 5 seconds (APV, HTST, Germany) to obtain a soft serve emulsion.

The emulsion was then passed through a Carpigiani ice-cream maker model Labo/8 12 E max capacity 2.5 L, for 1 L freezing time about 15 min to obtain a frozen dessert. The overrun was about 35%. The sample was tasted by 20 people. It was found that the soft serve had a very pleasant taste and mouthfeel with vanilla aroma. The mouthfeel was comparable to a typical ice cream made with milk fat components. In particular, a nice oat note could be obtained and addition of cereal to the ice-cream enables to obtain an amino acid score of 1.18 (Amino acid score would have been 1.09 if only chickpea was used) In addition, oat is usually much cheaper than Chickpea, thereby reducing the product price.

### Example 4

Soft Serve Emulsion and Frozen Dessert Comprising Chickpea and Oat in a 4:1 Ratio with Rheology Measurement.

5.1 wt % chickpea flour (AGT food) and 1.3 wt % oat flour (GMSA, Switzerland) were mixed with 68.87 wt % demineralized water to form a dispersion.

Chickpea flour was analyzed, and starch was 45%, protein 25%, fat 6%, dietary fiber 12% and sugar 8%. Oat flour contains 56% of starch, 13% of protein, 7% of fat, 10% dietary fiber and 1.2% sugar. 0.2% Pectin and 15% sugar were dry mixed together and added to the dispersion. The dispersion was then introduced into a Scanima reactor (Germany) and dispersion was mixed for 15 minutes. The mixture was then passed through a plate heat exchanger for 10 minutes at 95° C. in order to gelatinize the starch and to form a stable gel. The gel was then homogenized in a valve homogenizer (using a pressure of 250/50 bars to break the gel and avoid a graininess perception in the final frozen dessert product). 8 wt % of refined coconut fat was mixed with 0.4 wt % saturated monoglyceride at 75° C. to obtain a homogeneous lipid solution. The lipid solution was added to the homogenate by inline dosing. 0.3 wt % vanilla custard, 0.75 wt % milk cream flavor and 0.08 wt % Tonka flavor were added The complete dispersion was passed through the valve homogenizer using a relatively low pressure (80/20 bars) to obtain oil droplets The liquid was treated by ultra-high temperature treatment (UHT) using a temperature of 143° C. for 5 seconds to obtain a soft serve emulsion. The soft serve emulsion can be used to make a frozen dessert using a Taylor machine for example.

The particle size of the obtained soft serve emulsion was determined using a Malvern 3000 instrument using the Mie model with stirrer speed 2000, material name: coconut oil, refractive index 1.54, particle density 0.90 and absorption index 0.01, dispersant was water with sugar and corresponding refractive index 1.35. Result is the average of 5 measurements. D4,3 was found to be 14.3 microns, D3,2 was found to be 1.2 microns, Dx(90) was found to be 46 microns while the Dx(50) was 2 microns.

Viscosity of the soft serve emulsion was measured using a Physica MCR 501 (Anton Paar), with a Pelletier temperature at 25° C., with 20 points for 20 seconds for a shear rate of 0.005 to 0.1 s⁻¹ and 20 points for 10 seconds for a shear rate of 0.1 to 1000 s⁻¹. Bob length was 40 mm, bob diameter was 26.65 mm, cup diameter was 28.92 mm and active length was 120.2 mm. Viscosity was 0,150 Pas measured at a share rate of 100 s⁻¹.

### Example 5

Soft Serve Emulsion and Frozen Dessert Comprising Chickpea and Oat

5.1 wt % chickpea flour (AGT food) and 1.3 wt % oat flour (GMSA, Switzerland) were mixed with 56.87 wt % water to form a dispersion. Chickpea flour was analyzed, and starch was 45%, protein 25%, fat 6%, dietary fiber 12% and sugar 8%. Oat flour contains 56% of starch, 13% of protein, 7% of fat, 10% dietary fiber and 1.2% sugar. 0.2% Pectin and 12% sugar were dry mixed together and added to the dispersion. 10% Glucose syrup was then added. The dispersion was then introduced into a Tetra Almix B200-100 VA Scanima reactor (Germany) and heated to 95° C. The temperature was maintained for 10 minutes at 95° C. in order to gelatinize the starch and to form a stable gel. The gel was then homogenized in a valve homogenizer (APV, HTST, Germany) using a pressure of 350/50 bars to break the gel and avoid a graininess perception in the final frozen dessert product. 8 wt % of refined coconut fat was mixed with 0.4 wt % saturated monoglyceride at 75° C. to obtain a homogeneous lipid solution. The lipid solution was added to the homogenate. A pre-emulsion was obtained using a rotor stator. The complete dispersion was passed through the valve homogenizer (APV, HTST, Germany) using a relatively low pressure (80/20 bars) to obtain oil droplets with a maximum size of 5 microns as revealed by confocal microscopy using Nile red staining. 0.2 wt % vanilla custard, 0.5 wt % milk cream flavor and 0.08 wt % Tonka flavor were added to obtain the final soft serve emulsion.

Emulsion was then passed through a Carpigiani ice-cream maker model Labo/8 12 E max capacity 2.5 L, for 1 L freezing time about 15 min to obtain the frozen dessert. The overrun was about 35%. The sample was tasted by 20 people. It was found that the ice cream had a very pleasant taste and great mouthfeel with sustained vanilla aroma. The mouthfeel was comparable to a typical ice cream made with milk fat components. A nice flavour could be obtained. Ice cream was frozen (−18° C.) and remained spoonable with a constant taste during storage.

### Example 6

Soft Serve Emulsion and Frozen Dessert Comprising Chickpea

5.9 wt % chickpea flour (AGT food) was dispersed in 74% water. Chickpea flour was analyzed, and the starch content was 45 wt %, protein 25 wt %, fat 6 wt %, dietary fiber 12 wt % and sugar 8 wt %. 15 wt % sugar and added to the chickpea flour dispersion to form a mixture. pH was adjusted to a value of 7.2 using KOH. The mixture was then introduced into a Tetra Almix B200-100 VA Scanima reactor (Germany) and heated to 95° C. The temperature was maintained for 10 minutes at 95° C. in order to gelatinize the starch and to form a stable gel. 4 wt % of refined coconut fat was mixed with 0.4 wt % saturated monoglyceride at 75° C. to obtain a homogeneous lipid solution. The lipid solution was added to the chickpea/pectin/sugar mixture. A pre-emulsion was obtained using a rotor stator. 0.1 wt % vanilla custard, 0.5 wt % milk cream flavor and 0.1 wt % Vanilla bourbon flavour was were added. pH was adjusted to a value of 7.2 using KOH. The mixture was treated by ultra-high temperature treatment (UHT) using a temperature of 143° C. for 5 seconds (APV, HTST, Germany9). The complete dispersion was passed through a valve homogenizer (APV, HTST, Germany) using a relatively low pressure (80/20 bars) to obtain a soft serve emulsion.

The emulsion was passed through a Carpigiani ice-cream maker model Labo/8 12 E max capacity 2.5 L. The freezing time for 1 litre of emulsion was about 15 min. Overrun was about 30%.

### Example 7

Soft Serve Emulsion and Frozen Dessert Using Chickpea Flour and Hydrolized Oat Flour

4.5 wt % chickpea flour (AGT food) and 1.3 wt % hydrolyzed oat flour (Grainmillers, USA) were mixed with 74 wt % demineralized water to form a dispersion. 15 wt % sugar was added. Chickpea flour was analyzed, and starch was 50%, protein 20%, fat 6%, dietary fiber 12% and sugar 8%. Hydrolyzed oat flour contains 64% of starch, 13% of protein, 7.5% of fat, 9% dietary fiber and 1.2% sugar. The pH was adjusted to a value of 7.2 using KOH. The dispersion was then introduced into a Scanima reactor (Germany) and dispersion was mixed for 15 minutes. The mixture was then passed through a plate heat exchanger for 10 minutes at 95° C. in order to gelatinize the starch and to form a stable gel. 4 wt % of refined coconut fat was mixed with 0.3 wt % saturated monoglyceride and 0.08 wt % unsaturated monoglycerides at 75° C. to obtain a homogeneous lipid solution. The lipid solution was added to the homogenate by inline dosing. 0.15 wt % vanilla custard, 0.02 wt % and Vanilla Bourbon flavor 0.05 wt % Milk cream flavour were added. The liquid was treated by ultra-high temperature treatment (UHT) using a temperature of 143° C. for 5 seconds to obtain the soft serve emulsion. The complete dispersion was passed through the valve homogenizer using a relatively low pressure (80/20 bars) to obtain oil droplets. A soft serve mix emulsion was obtained, which was used to make delicious Soft Serve frozen desserts using a Taylor machine. The soft serve emulsion did not evolve during storage for more than 4 months. Furthermore, it did not phase separate during the cycle of a Taylor machine, which involves storage at 4° C. and one heating by day at 70° C. to ensure microbiological safety over the course of 1 week. At the end of the week, the taste and texture of the frozen dessert was still outstanding.

Viscosity was measured using a Physica MCR 501 (Anton Paar), with a Pelletier temperature at 25° C., with 20 points for 20 seconds for a shear rate of 0.005 to 0.1 s⁻¹ and 20 points for 10 seconds for a shear rate of 0.1 to 1000 s⁻¹. Bob length was 40 mm, bob diameter was 26.65 mm, cup diameter was 28.92 mm and active length: 120.2 mm. Viscosity was 0.04 Pas measured at a share rate of 100 s⁻¹. Due to the use of hydrolysed oat flour, and downstream homogenization (homogenization done after UHT), viscosity is relatively low thus ensuring good functioning of the Soft serve machine even when the product remains for a long time (e.g. several weeks) at temperature in the range of 2 to 4° C. typical of Soft Serve machine.

### Example 8

Soft Serve Emulsion and Frozen Dessert Comprising Chickpea and Oat

5.1 wt % chickpea flour (AGT food) and 1.3 wt % oat flour (GMSA, Switzerland) were mixed with 70.07 wt % water to form a dispersion.

Chickpea flour was analyzed, and starch was 45%, protein 25%, fat 6%, dietary fiber 12% and sugar 8%. Oat flour contains 56% of starch, 13% of protein, 7% of fat, 10% dietary fiber and 1.2% sugar. 15% sugar was added to the dispersion. The dispersion was then introduced into a Tetra Almix B200-100 VA Scanima reactor (Germany) and heated 15 minutes at 90° C., followed by cooling down to 80° C. 0.001 wt %, in reference to total dispersion weight, of Ban 800 (Novozymes, Denmark) was added and temperature was maintained at 80° C. for 10 minutes for hydrolysing the starch. 8 wt % of refined coconut fat was mixed with 0.4 wt % saturated monoglyceride at 75° C. to obtain a homogeneous lipid solution. The lipid solution was added to the flour/sugar dispersion. A pre-emulsion was obtained using a rotor stator. The complete dispersion was passed through the valve homogenizer (APV, HTST, Germany) using a relatively low pressure (80/20 bars). 0.3 wt % vanilla custard, 0.75 wt % milk cream flavor and 0.08 wt % Tonka flavor were added. The liquid was treated by ultra-high temperature treatment (UHT) using a temperature of 143° C. for 5 seconds (APV, HTST, Germany) to obtain the soft serve emulsion.

### Example 9

Comparison Between a Frozen Dessert Processed Using Chickpea Flour Only and a Frozen Dessert Processed Using Chickpea Flour and Oat Flour.

Chickpea Soft Serve Emulsion

6.4 wt % chickpea flour (AGT food) was dispersed in 69.12% water. A dry mix was made of 0.2 wt % pectin and 15 wt % sugar and added to the chickpea flour dispersion to form a mixture. The mixture was then introduced into a Tetra Almix B200-100 VA Scanima reactor (Germany) and heated to 95° C. The temperature was maintained for 10 minutes at 95° C. in order to gelatinize the starch and to form a stable gel. The mixture was then homogenized in a valve homogenizer (APV, HTST, Germany) using a pressure of 350/50 bars. 8 wt % of refined coconut fat was mixed with 0.4 wt % saturated monoglyceride at 75° C. to obtain a homogeneous lipid solution. The lipid solution was added to the chickpea/pectin/sugar mixture. A pre-emulsion was obtained using a rotor stator. The complete dispersion was passed through the valve homogenizer (APV, HTST, Germany) using a relatively low pressure (80/20 bars). 0.2 wt % vanilla custard, 0.5 wt % milk cream flavor and 0.08 wt % Tonka flavor were added to the emulsion.

### Example 10

Soft Serve Emulsion and Frozen Dessert Comprising Chickpea and Oat

5.1 wt % chickpea flour (AGT food) and 1.3 wt % oat flour (GMSA, Switzerland) were dispersed in 69.12% water. A dry mix was made of 0.2 wt % pectin and 15 wt % sugar and added to the chickpea flour dispersion to form a mixture. The mixture was then introduced into a Tetra Almix B200-100 VA Scanima reactor (Germany) and heated to 95° C. The temperature was maintained for 10 minutes at 95° C. in order to gelatinize the starch and to form a stable gel. The mixture was then homogenized in a valve homogenizer (APV, HTST, Germany) using a pressure of 350/50 bars. 8 wt % of refined coconut fat was mixed with 0.4 wt % saturated monoglyceride at 75° C. to obtain a homogeneous lipid solution. The lipid solution was added to the chickpea/pectin/sugar mixture. A pre-emulsion was obtained using a rotor stator. The complete dispersion was passed through the valve homogenizer (APV, HTST, Germany) using a relatively low pressure (80/20 bars). 0.2 wt % vanilla custard, 0.5 wt % milk cream flavor and 0.08 wt % Tonka flavor were added to the emulsion.

The 2 emulsions were then passed through a Carpigiani ice-cream maker model Labo/8 12 E max capacity 2.5 L, for 1 L freezing time about 15 min. The obtained frozen desserts were tasted. It was found that the one containing oat flour had higher mouthfeel was more round in taste containing less perceived legume replace by a pleasant slight oat note compared to the one with only chickpea

### Example 11

Soft Serve Emulsion and Frozen Dessert with Additional Cocoa Powder

4.275 wt % chickpea flour (AGT food), 1.235 wt % hydrolyzed oat flour (Grainmillers, USA), and 3.5% Cocoa powder (D11CK, ADM, the Netherland) were mixed with 70,248 wt % demineralized water to form a dispersion. Cocoa powder is obtained using cleaning, breaking, de-shelling, alkalizing roasting, grinding, pressing and tempering. This process enables to obtain a partially defatted powder from cocoa bean, Final fat content of the powder is in the range 10 to 12 wt %. 16.5 wt % sugar was added. The pH was adjusted to a value of 7.2 using KOH. The dispersion was then introduced into a Scanima reactor (Germany) and dispersion was mixed for 15 minutes. The mixture was then passed through a plate heat exchanger for 45 minutes at 95° C. in order to gelatinize the starch and to form a stable gel and to kill any spores ot microbiological organisms remaining. 4 wt % of refined coconut fat was mixed with 0.38 wt % saturated monoglyceride at 75° C. to obtain a homogeneous lipid solution. The lipid solution was added to the homogenate by inline dosing. 0,095 wt % salt, 0.178 wt % vanilla custard, 0.024 wt % and Vanilla Bourbon flavor 0.059 wt % Milk cream flavour were added. The liquid was treated by ultra-high temperature treatment (UHT) using a temperature of 143° C. for 5 seconds. The complete dispersion was passed through the valve homogenizer using a relatively low pressure (80/20 bars) to obtain large oil droplets. A soft serve emulsion was obtained, which was used to make delicious chocolate frozen dessert using a Taylor machine.

1. A soft serve emulsion composition or frozen dessert composition, said composition comprising
a. 1 to 10 wt % non-fractionated chickpea;
b. 0.2 to 5 wt % non-fractionated oat;
c. 1 to 45 wt % sugar; and
d. 3 to 20 wt % fat source.

2. The composition according to claim 1, wherein the composition comprises 0.5 to 5 wt % protein.

3. The composition according to claim 2, wherein greater than 50% of the protein is provided by one or more of the non-fractionated chickpea and non-fractionated oat.

4. The composition according to claim 1, wherein the composition comprises 1 to 10 wt % starch.

5. The composition according to claim 1, wherein the composition comprises 0.2 to 5 wt % dietary fiber.

6. The composition according to claim 1, wherein the composition has an amino acid score greater than 0.9.

7. The composition according to claim 1, wherein the composition has an overrun of between 15 to 100%.

8. A method of making a plant based liquid, soft serve emulsion, or a frozen dessert composition, said method comprising
Mixing 1 to 10 wt % non-fractionated legume, 0.2 to 5 wt % non-fractionated cereal, sugar, and optionally pectin in water to form a mixture;
Heating the mixture to induce starch gelation;
Adding a fat source to the mixture;
Homogenizing the mixture comprising the fat source at relatively low shear to obtain large fat particle sizes to remain and gives a creamy frozen dessert without graininess-t and
Applying a thermal heat treatment to the mixture to form a plant based liquid composition.

9. The method according to claim 8, wherein the non-fractionated legume is chickpea and the non-fractionated cereal is oat.

10. The method according to claim 8, wherein the mixture is heated to at least 70° C. to induce gelatinization.

11. The method according to claim 8, wherein the mixture comprising the fat source is homogenized at about 80/20 bars or less.

12. The method according to claim 8, wherein the plant based liquid in-step-g)-comprises lipid droplets having a maximum diameter greater than 1 microns.

13. The method according to claim 8, wherein the plant based liquid has a D4,3 particle size less than 100 microns.

14. The method according to claim 8, wherein the mixture has a viscosity higher than 0.001 Pa s as measured at 25° C. with apparatus at a shear rate of 100 s-1.

15. (canceled)
